(19) United States
(12) Patent Application Publication
(10) Pub. No.: US 2008/0216240 A1
(43) Pub. Date: Sep. 11, 2008

(54) Bed

(76) Inventor: Alberto Valli, Trento (IT)

Correspondence Address: MODIANO & ASSOCIATI, Via Meravigli, 16, Milano, 20123, IT

(21) Appl. No.: 10/588,225

(22) PCT Filed: Feb. 17, 2005
(86) PCT No.: PCT/EP05/01621

§ 371 Date: Aug. 3, 2006

(30) Foreign Application Priority Data
Feb. 25, 2004 (IT) VR2004A000025

(51) Int. Cl. A61G 7/008; A61G 7/015

(52) U.S. Cl. 5/608; 5/609

(57) ABSTRACT

A bed comprising a supporting structure for a resting element that lies along a main longitudinal axis, wherein said resting element is associated with movement elements that are adapted to move on command the resting element with an oscillating motion about a tilting axis that is substantially parallel to the main longitudinal axis.

### TECHNICAL FIELD

The present invention relates to a bed, particularly adapted to be used if the patient has extreme difficulty in movement but also for everyday use.

### BACKGROUND ART

It is known in fact that the rising age of the population and the need to maintain the patient even in extreme cases (absolute inability of the patient to move, comatose patients, post-femur surgery patients, patients with a fractured pelvis, post-trauma patients or neoplastic patients, et cetera), have increased the need to seek solutions to ensure better living conditions especially for patients who are forced to remain in bed. This requirement is felt even more strongly due to the continuing reduction in nursing staff and in personnel assigned to patient assistance.

Various kinds of beds are currently commercially available which are provided with various movement devices that are designed to increase patient comfort; however, such beds are not always suitable for these kinds of patients or do not always reduce their needs and the intervention time of support staff, but most of all do not meet the requirements in terms of movement and especially rehabilitation of those people who are bedridden for months or years.

In general, the beds that are used in fact have movement devices that allow to lift (manually or automatically) the back and/or end part of the bed so as to make the patient's bedridden time more comfortable.

However, from a clinical standpoint it would be good medical and nursing practice for support staff to turn over on their sides (alternately) bedridden and immobile patients every two/three hours, in order to avoid bedsores and skin problems caused by immobility and stasis. However, unfortunately, this practice is often only theoretical, especially during the night, due to chronic lack of personnel but also due to difficulty in moving this type of patients, which often would require considerable physical effort.

As mentioned, this problem is, and will be in the future, increasingly important due to the fact that on the one hand the number of patients who have severe brain damage (for example following a stroke) or are otherwise bedridden continues to increase (also due to the increase in average age), and on the other hand the life expectancy of these patients who are immobilized for any reason is increasing and so are the expectations of their relatives, with the need for support staff to provide better care to them.

### DISCLOSURE OF THE INVENTION

The aim of the present invention is to provide a bed that allows to eliminate or at least drastically reduce the drawbacks noted above in the beds that are currently used.

Within this aim, an object of the present invention is to provide a bed that allows, if necessary, continuous mobilization of patient.

Another object of the invention is to provide a bed that allows to reduce, or better still eliminate, the risk of bedsores.

A further object of the invention is to begin the earliest possible rehabilitation even in comatose patients or patients with pelvis fractures, hip surgery patients, et cetera.

A still further object of the invention is to facilitate patient cleansing operations, without having to take the patient to the bathtub and immerse him in the bathtub by using lifting devices and carrying the patient from his room to the bathroom, and to reduce the physical efforts of the nursing or support staff and their constant intervention and therefore reduce their commitment, or at least partly free them from having to continuously mobilize the patient with a considerable waste of physical energy.

According to another aspect, a further object of the invention is to provide a bed that can be converted, according to requirements, into an armchair in order to begin immediately the rehabilitation and mobilization of the patient and increase his degree of rehabilitation while occupying a limited area.

Another object of the invention is to provide a bed that has a very simple structure, is highly durable and easy to use, and has a competitive production cost, obviously in relation to the large number of functions that it can perform, in order to be advantageous also from an economical standpoint.

This aim and these and other objects that will become better apparent hereinafter are achieved by a bed according to invention, which comprises a supporting structure for a resting element that lies along a main longitudinal axis, characterized in that said resting element is associated with movement means that are adapted to move on command said resting element with an oscillating motion about an axis that is substantially parallel to said main longitudinal axis.

According to another aspect, a bed according to the present invention is characterized in that the resting element has at least two transverse portions that are arranged in succession along the main longitudinal axis, said at least two transverse portions having mutual interconnection means that allow, on command, an angular movement of one transverse portion with respect to the other transverse portion about a transverse axis that is substantially perpendicular to the main longitudinal axis.

### BRIEF DESCRIPTION OF THE DRAWINGS

Further characteristics and advantages of the invention will become better apparent from the description of some preferred but not exclusive embodiments of a bed according to invention, illustrated by way of non-limiting example in the accompanying drawings, wherein:

FIG. 1 is a perspective view of a bed according to the present invention;

FIG. 2 is a transverse sectional view of the bed shown in FIG. 1;

FIG. 3 is a perspective view of a “head” portion of a bed according to the invention;

FIG. 4 is a view, similar to FIG. 3 but of the opposite portion, of the bed;

FIG. 5 is a perspective view of a mattress device;

FIG. 6 is a transverse sectional view of a variation of a resting element in a shell-like configuration;

FIG. 7 is a sectional view, similar to the one shown in FIG. 6, but with the shell-like element in a substantially flat configuration;

FIG. 8 is a side elevation view of the bed in an “armchair configuration”;

FIG. 9 is an enlarged-scale view of connection means shown in FIG. 8;

FIG. 10 is a side elevation view of another variation of the bed;

FIG. 11 is a partial front elevation view of the variation shown in FIG. 10;

FIG. 12 is a partial and enlarged-scale transverse sectional view of the bed;

FIG. 13 is a sectional view, taken along a substantially longitudinal line, of an example of embodiment of the connection means;

FIG. 14 is a perspective view of another variation of a bed according to the invention;

FIG. 15 is a perspective view of the variation of the bed shown in FIG. 14, in the shell-like configuration;

FIG. 16 is a perspective view of a part of the bed according to the variation of FIGS. 14 and 15 in the shell-like configuration and during tilting;

FIG. 17 is a transverse sectional view of the resting element; and

FIG. 18 is a front elevation view of an example of embodiment of a bed.

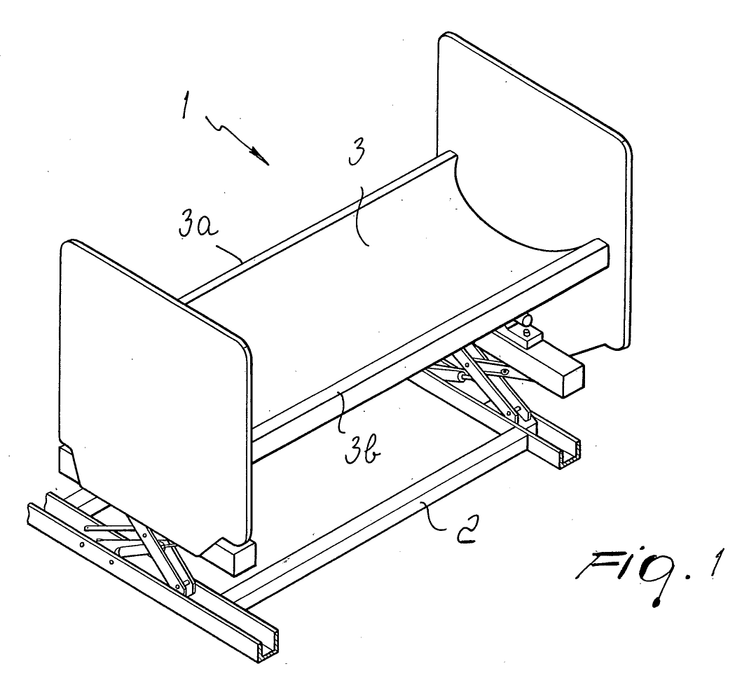

### WAYS OF CARRYING OUT THE INVENTION

In the examples of embodiments that follow, individual characteristics, given in relation to specific examples, may actually be interchanged with other different characteristics that exist in other examples of embodiments.

Moreover, it should be noted that anything found to be already known during the patenting process is understood not to be claimed and to be the subject of a disclaimer.

With reference to the figures, a bed according to the invention, generally designated by the reference numeral 1, comprises a supporting structure 2 for a resting element 3.

The resting element 3 lies along a main axis (which is substantially longitudinal) and according to the present invention is associated with movement means 5, which are adapted to move on command said resting element 3 with an oscillating motion about a tilting axis 100 that is substantially parallel to the main axis.

In particular, with reference to the figures, the resting element 3 may have a concave region that is directed upwardly during use, i.e., toward its upper surface, which is designed to accommodate the patient during use.

The resting element 3 can be constituted by at least two transverse portions 6a and 6b, which are arranged in succession along the longitudinal main axis: in particular, the transverse portions 6a and 6b are associated by virtue of mutual connection means 7, which are adapted to allow on command an angular movement of one transverse portion 6a with respect to the other transverse portion 6b about a transverse axis 101 that is substantially perpendicular to the main axis (and therefore to the tilting axis 100).

Conveniently, the resting element 3 has a substantially shell-like or semicylindrical shape.

According to an important aspect of the present invention, the bed 1 comprises conversion means adapted to convert the resting element 3 from a flat condition to a substantially shell-like shape.

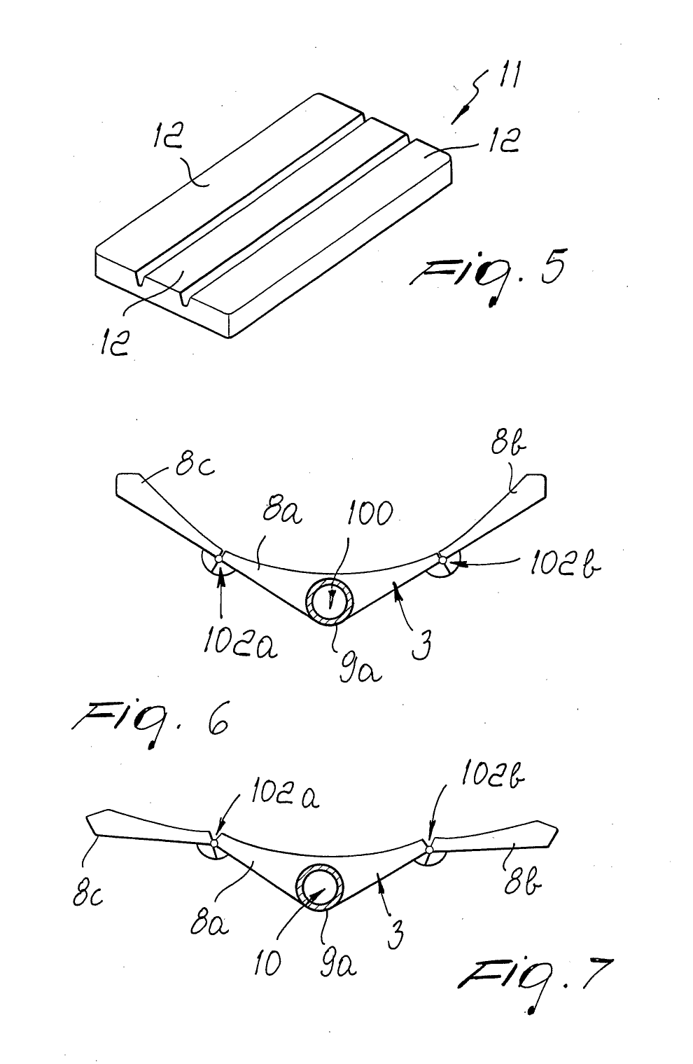

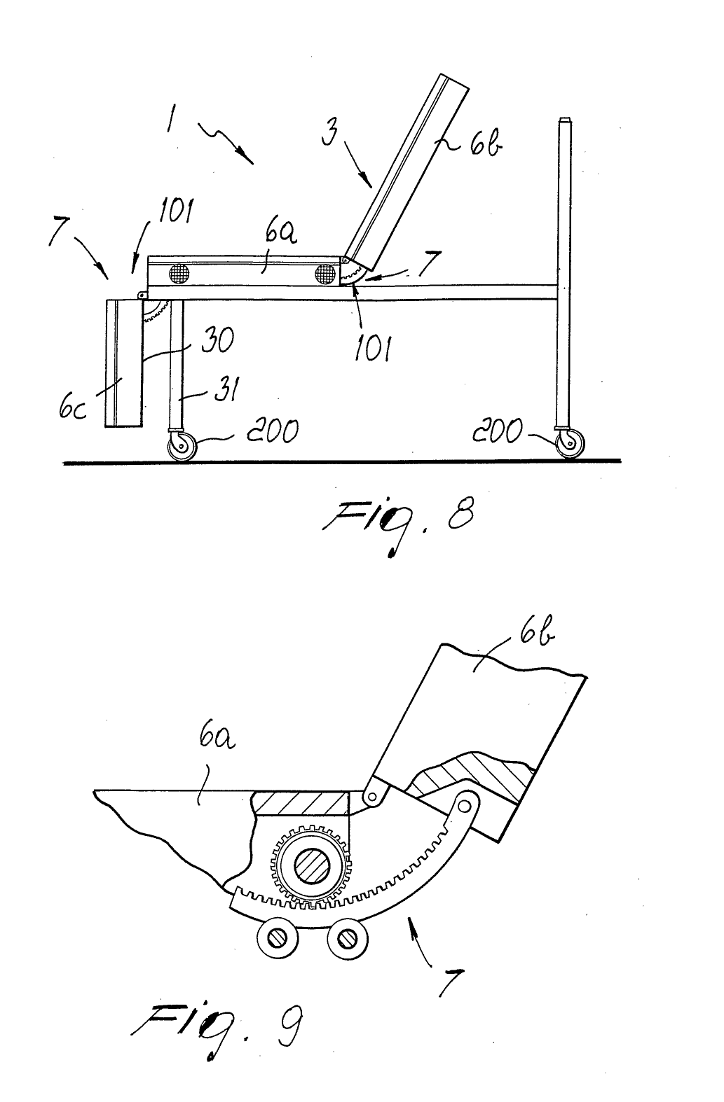

According to a preferred embodiment, the substantially shell-like shape can be obtained by providing the resting element 3 so that it is constituted by at least three longitudinal elements 8a, 8b and 8c, which can be moved with respect to each other about respective connecting axes 102a and 102b in order to shift between a flat condition (shown in FIG. 7), in which the three longitudinal elements 8a, 8b and 8c lie substantially on the same plane of arrangement, and a shell-like condition (clearly shown in FIG. 6), in which the three longitudinal elements 8a, 8b and 8c cooperate in order to achieve the above described substantially shell-like or semicylindrical configuration.

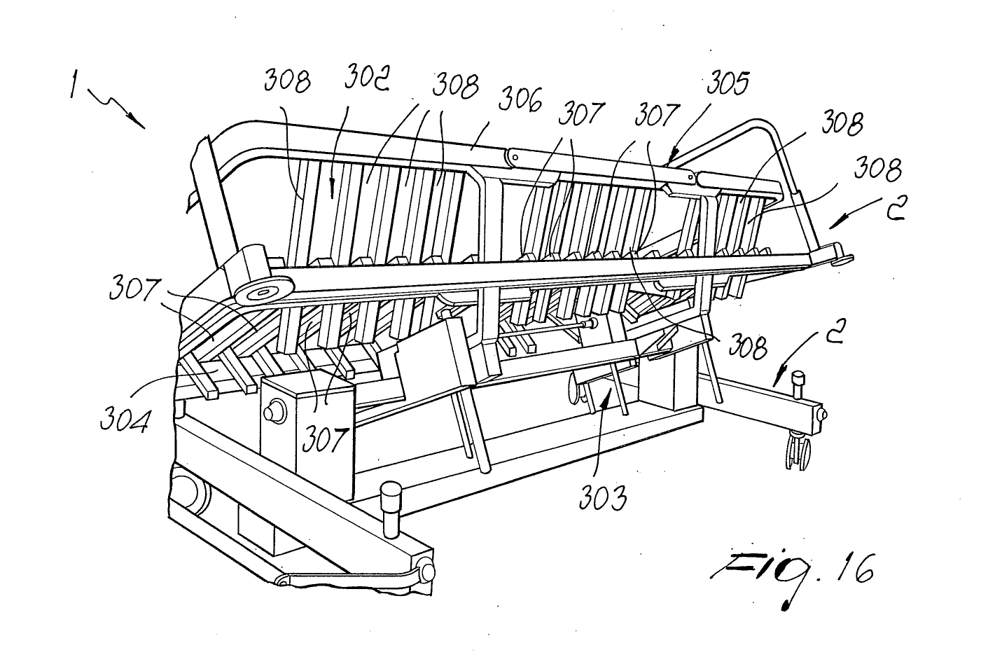

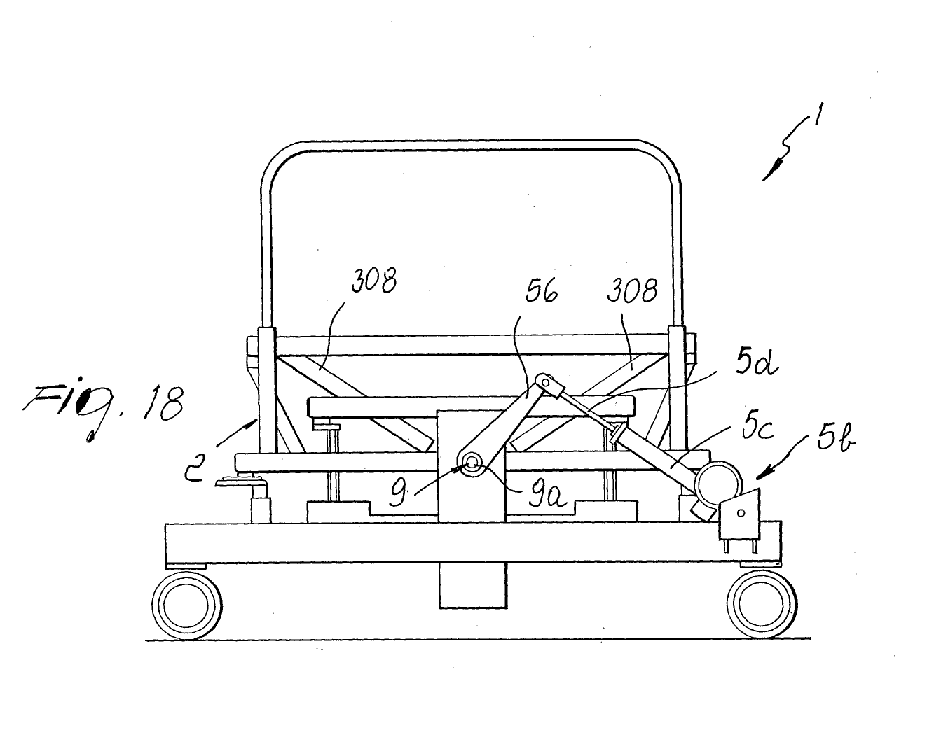

With reference now to the embodiment shown in FIGS. 15 to 17, the resting element 3 comprises an internal longitudinal portion 301 and at least two longitudinal external portions 302, which are arranged on opposite sides with respect to the internal longitudinal portion 301.

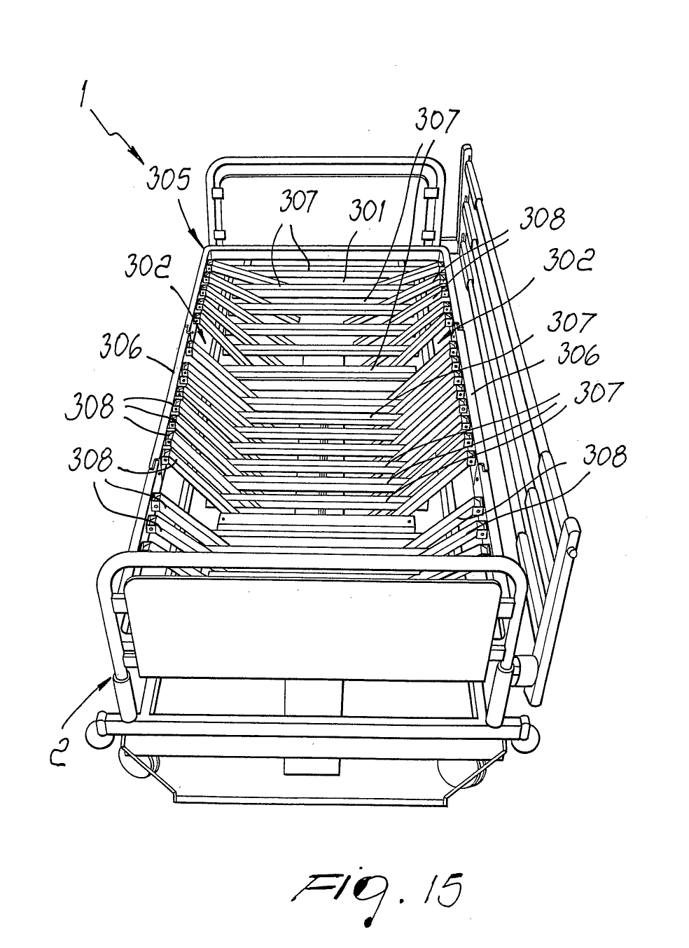

As shown in FIG. 14, the internal longitudinal portion 301 and the external longitudinal portions 302 lie on the same plane of arrangement when the resting element 3 is in the flat condition.

In this embodiment, the conversion means comprise means 303 for lifting/lowering the internal longitudinal portion 301 with respect to the supporting structure 2 and means for the angular movement, about a respective movement axis that is substantially parallel to the main longitudinal axis, of the external longitudinal portions 302 in order to obtain the shell-like configuration (FIG. 15).

Conveniently, the internal longitudinal portion 301 comprises at least one pair of longitudinal members 304, while the supporting structure 2 supports an external profile 305, which is provided with two supporting bars 306.

In particular, each one of the external longitudinal portions 302 is associated with a respective longitudinal member 304 and with a respective supporting bar 306, which are arranged on the same side with respect to the internal longitudinal portion 301.

The lifting/lowering means 303, in this particular case, are adapted to move the pair of longitudinal members 304 (and therefore the internal longitudinal portion 301) with respect to the external profile 305 along a direction that is substantially perpendicular to the plane of arrangement of the internal longitudinal portion 301 and to move in an angular fashion the external longitudinal portions 302 about a respective angular movement axis.

Advantageously, the two longitudinal members 304 support a first plurality of cross-members 307, which are mutually spaced along the main longitudinal axis; moreover, there are second pluralities of cross-members 308, which are also mutually spaced along the main longitudinal axis and are associated with the supporting bars 306 and with the longitudinal members 304. It is convenient to offset the second pluralities of cross-members 308 with respect to the first plurality of cross-members 307.

In particular, according to a preferred embodiment, each cross-member of the second plurality of cross-members 308 has a first portion 308a for pivoting to a respective supporting bar 306 and a second end 308b that is supported so that it can slide by a respective longitudinal member 304.

Advantageously, as shown in FIG. 15, the longitudinal members 304 have, at the respective end portions arranged toward the head of the bed and/or towards the foot of the bed, a diverging arrangement, so that at the region that is designed to be engaged by the shoulders and head of the user, and optionally by his feet, the external longitudinal portions have a connecting region that ensures that the shoulders and the head (and/or the feet) are kept fully supported on the internal longitudinal portion, which is wider.

In greater detail, the movement means 5 comprise motor means 6 (constituted for example by a direct-current electric motor), which are kinematically connected to at least one movement element 9.

According to one example of embodiment, the movement element 9 can be constituted by a respective movement shaft 9a, which is adapted to rotate with an alternating back-and-forth motion in order to cause the oscillation of the resting element 3 about the tilting axis 100.

With particular reference to the elevation view of FIG. 18, the movement means 5 can be conveniently constituted by an electric motor 5b, which is associated with a linear actuator 5c in which the stem 5d is kinematically connected to a movement lever system 5e that is associated with the movement shaft 9a.

In order to allow the rotation of the entire resting element 3 about the tilting axis 100, if there are one or more transverse axes 101, each transverse portion 6a and 6b can be associated with a respective movement element 9.

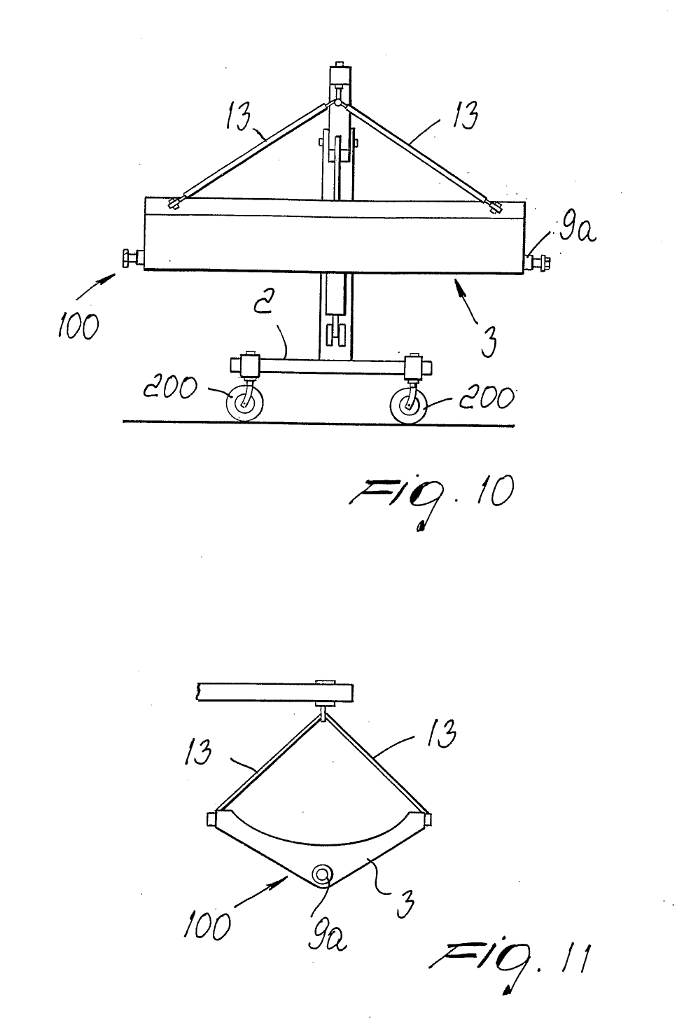

With reference to the embodiment shown in FIGS. 8 and 9, the resting element 3 can be constituted by one (or more) intermediate transverse portion or portions 6a, by a transverse head portion 6b, and by a transverse foot portion 6c.

In this case, of course, means 7 are provided for mutually connecting the intermediate transverse portion 6a and the transverse foot portion 6c and, in a fully equivalent manner, the intermediate transverse portion 6a and the transverse head portion 6b.

It is evident that the configuration of the resting element 3 with at least three transverse portions allows to convert the bed into an armchair. In this regard, it is convenient to provide the possibility to remove the footboard 30 or to fold it below the transverse foot portion 6c in order to move it into the condition shown in FIG. 8.

In order to facilitate conversion from the “bed configuration” to the “armchair configuration”, the supporting structure 2 should be conveniently provided with two supporting feet 31 connected to the intermediate transverse portion 6a.

However, the supporting structure 2 may also comprise two rear supporting feet, which however must be collapsible in order to allow to fold away any portion of the supporting structure 2 that is arranged between the transverse axis 101 formed between the intermediate transverse portion 6a and the transverse foot portion 6c and the foot of the bed, so as to significantly reduce the longitudinal space occupation when the bed 1 according to the invention is in the “armchair configuration”.

Conveniently, the supporting feet may be associated with wheels or optionally casters 200 provided with braking means 201.

With particular reference to the embodiment described above, which allows transition from the “bed configuration” to the “armchair configuration”, the movement means 5 should be provided conveniently with devices 10 for articulation between the movement elements 9 arranged in succession. These articulated devices are structured so as to allow to transmit rotary motion among the movement elements 9 arranged in succession, but at the same time they allow to mutually incline the longitudinal axes of the movement elements 9.

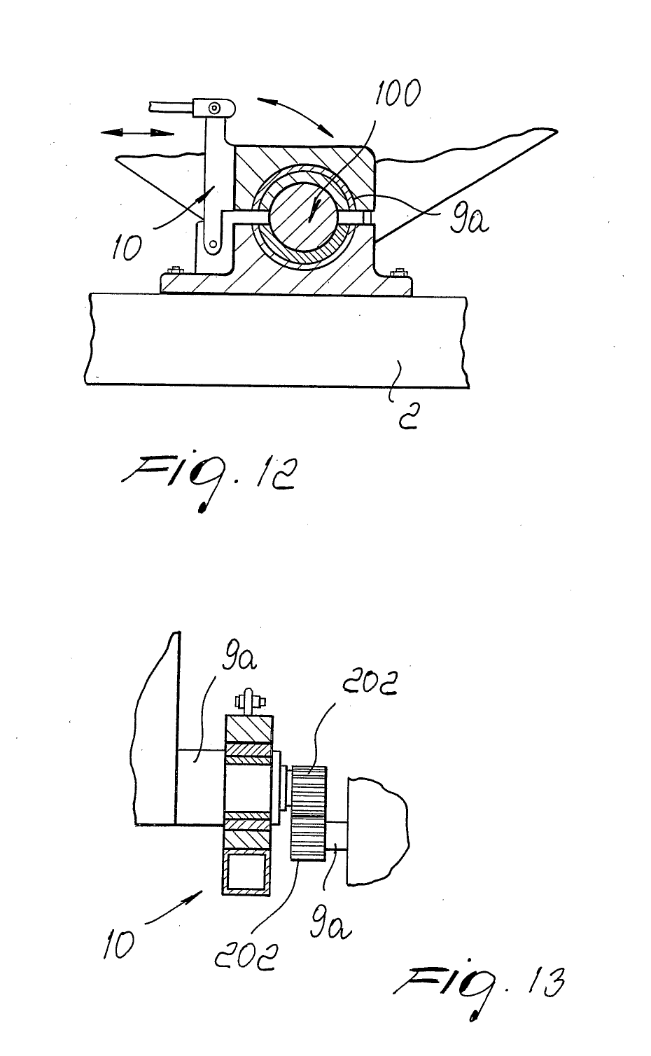

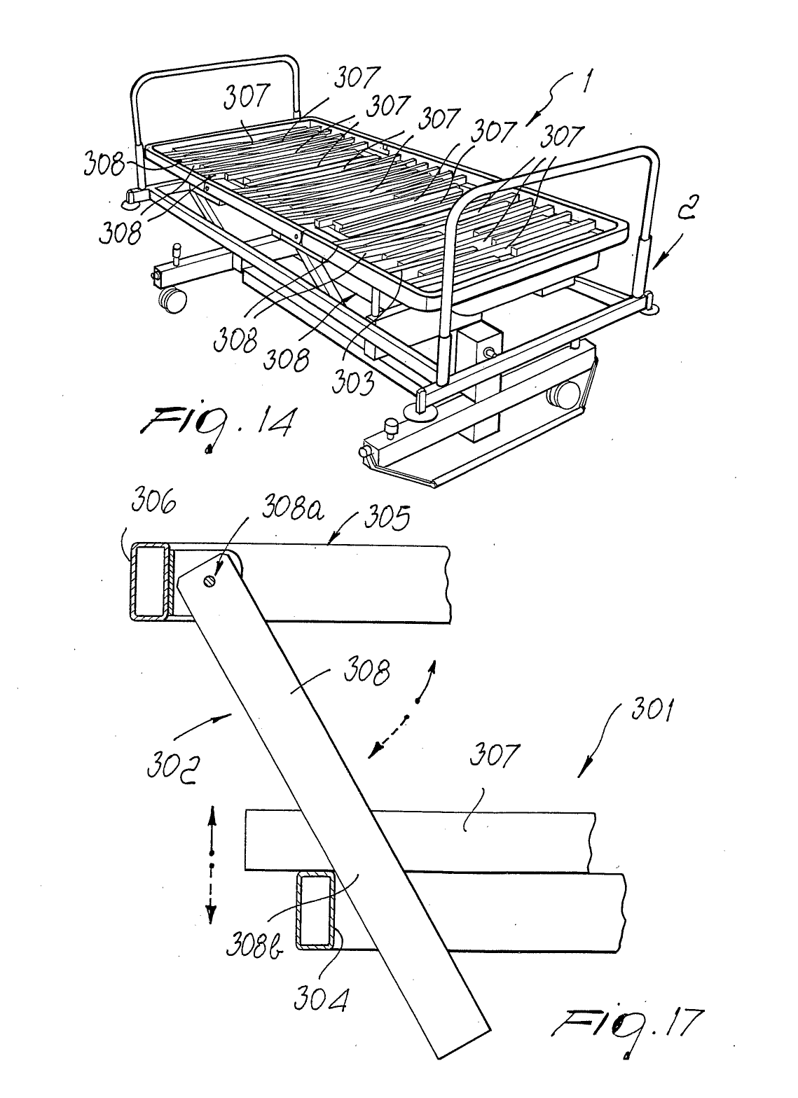

Merely by way of example, said articulated devices can be constituted by a spherical coupling or, as shown in FIG. 13, they can be provided by providing a connecting gear 202 at the end portions of the respective movement shafts 9a. With reference to this embodiment, the respective connecting gears 202 are meshed (as shown in FIG. 13) when the bed 1 is in the bed configuration and accordingly, in this position, all the movement shafts 9a are mutually kinematically connected, so as to ensure a simultaneous rotation of all the transverse portions.

Advantageously, the resting element 3 can be fitted so that it can rotate about a substantially vertical axis on the supporting structure 2, so as to allow, if the resting element 3 is to be converted into an armchair, the rotation through 90° of the resting element 3 about the substantially vertical axis, allowing easier relative rotation among the respective transverse portions.

For example, it is possible to connect the resting element 3 to the supporting structure 2 by interposing a spherical joint that is capable of ensuring at the same time the ability of the resting element 3 to rotate with respect to the supporting structure 2, both about a substantially vertical axis (to facilitate conversion from a bed to an armchair) and about the tilting axis.

With particular reference to FIG. 5, the bed 1 comprises a mattress device 11, which during use is designed to be arranged above the resting element 3 in order to ensure that the patient has a comfortable resting surface.

Conveniently, the mattress device 11 comprises a plurality of mattresses 12, which are adapted to have their respective peripheral edges 12a arranged at the transverse axes 101 and at the mutual connection means 7 in a crisscross arrangement.

Advantageously, the individual mattresses 12 can be kept compacted together by using a mattress case or an elasticated sheet.

In order to ensure patient safety during the oscillating motion of the resting element 3 about the tilting axis 100, the shell element 3 is connected, at its longitudinal and upper edges 3a and 3b, to a respective protective side 13.

Such protective sides 13 may of course be disengageable from the respective longitudinal upper edge 3a or 3b or, equivalently, they can be collapsible by means of a controlled downward rotation. The sides 13 may also be constituted by longitudinal bars, which are mutually connected by way of net or cord portions, so as to prevent the passage of an arm or hand of the bedridden patient.

However, one or both protective sides 13 might also be associated with guiding means that are adapted to keep the respective protective side 13 substantially vertical even during the oscillating motion of the resting element 3.

Advantageously, the bed 1 can be associated with covering means which may, according to a preferred embodiment, be detachably associable above the mattress device 11 and can be constituted in particular by a shell-shaped panel that is substantially waterproof.

The covering means may of course be constituted by an impermeable sheet that is capable of following the shape of the shell-like element 3.

Operation of the bed 1 according to the present invention is strictly derivable from what has been described above.

If the bed 1 is intended to accommodate a substantially immobilized patient, by acting for example on a control panel it is in fact possible to control the movement means so as to actuate the motor means in order to allow an alternating back-and-forth motion of the movement elements and therefore an oscillating motion of the resting element about the tilting axis.

In particular, it has been observed that by setting the movement means so that the shell-like element oscillates through approximately 12-25°, transition of the patient from the supine position to the side-lying position is insured, thus discharging the weight of the rear muscles of the backbone gradually onto the right or left side, depending on the rotation of the bed.

In this regard, it is quite possible to increase or decrease, according to requirements, the oscillation angle of the shell-like element.

By using per se known control devices, it is possible to actuate the movement means in order to set the oscillation time depending on the requirements of the patient and on the operations to be performed by the support staff.

In particular, in normal conditions (resting patient) it is possible to set a continuous rotation cycle, on the order of approximately two hours, for full oscillation about the tilting axis. In the case of intervention by nursing or support staff (changing bedsheets, washing the patient), it is possible to set a distinctly shorter rotation/oscillation time, for example on the order of a few seconds or one minute.

All the characteristics of the invention described above as advantageous, convenient or the like may also be omitted or replaced with equivalents.

The invention thus conceived is susceptible of numerous modifications and variations, all of which are within the scope of the appended claims.

Thus, for example, the resting element may also be constituted by a nonrigid surface (for example a net or a sheet that can be anchored to the supporting structure), tension whereof can be adjusted in order to allow its conversion from the flat condition to the substantially shell-shaped configuration.

Moreover, the resting element may have a plurality of cushions that run parallel to the main longitudinal axis and can be inflated with various fluids (in the gaseous or liquid state) by means of pump devices or the like, so as to obtain at will the flat condition or the substantially shell-like configuration.

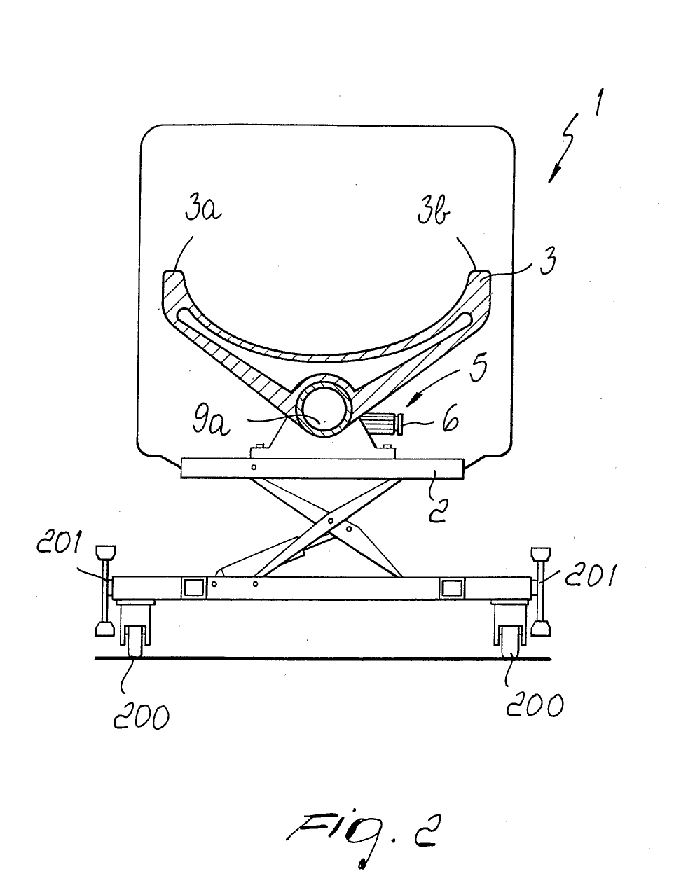

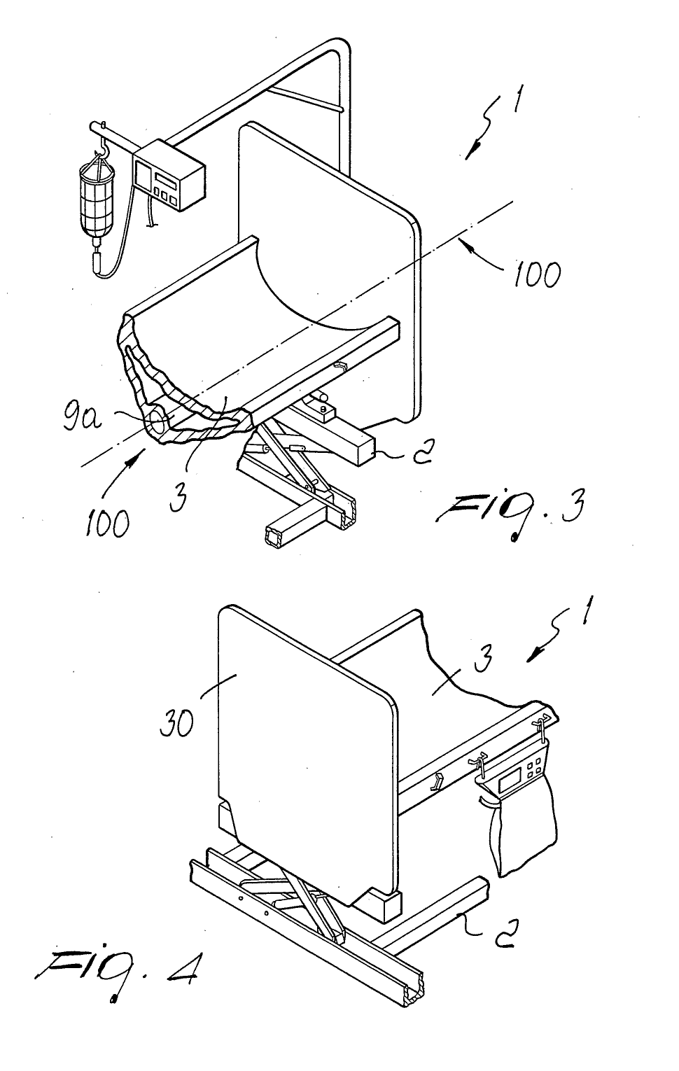

It is evident that as regards the tilting axis about which the resting element oscillates, it can be a “real” axis (i.e., belonging to the resting element as in the examples shown in FIGS. 2 and 6), but it can also be of the “virtual” type (arranged for example above the resting element) if, for example, there are devices with sliders or rollers for moving the resting element.

Moreover, it is possible to have, between the supporting structure and the shell-like element, shock-absorbing elements that are adapted to compensate for any anomalies in the operation of the motor means.

In practice it has been observed that in all the embodiments the invention has achieved the intended aim and objects.

In particular, it has been observed that the bed described above can easily allow to reduce the efforts of nursing staff in moving the patient.

Thanks to the possibility to cause the oscillation of the resting element, the patient is in fact ensured support (and therefore stress caused by pressure) at a continuously different part of the body, so as to reduce bedsores (by limiting their risk).

Moreover, it is evident that the bed, if associated with the covering means, allows to wash and dry the immobilized patient rapidly and effectively, also by virtue of the fact that thanks to the presence of the shell-like element elimination of any excess of water is facilitated.

Washing is in fact greatly facilitated, since the covering means, by being shaped substantially like the resting element, allow to convey the water toward the bottom of the bed, preventing its stagnation.

In addition to what has been described above, it has been found that if the bed can be converted into an armchair, the bed allows to move the patient from a reclining condition to a condition in which he is at least partially sitting without having to leave the bed: this allows rapid rehabilitation even for patients who are unable to move autonomously, without requiring efforts on the part of the support staff, so as to make the patient resume his vital functions.

In practice, the materials used, so long as they are compatible with the contingent use, as well as the shapes and dimensions, may be any according to requirements.

All the details may further be replaced with other technically equivalent elements.

The disclosures in Italian Patent Application No. VR2004A000025 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

What is claimed is:

1-21. (canceled)

22. A bed comprising a supporting structure for a resting element that lies along a main longitudinal axis, wherein said resting element is associated with movement means that are adapted to move on command said resting element with an oscillating motion about a tilting axis that is substantially parallel to said main longitudinal axis.

23. The bed according to claim 22, wherein it comprises conversion means that are adapted to convert said resting element from a flat condition to a substantially shell-like configuration.

24. The bed according to claim 22, wherein said resting element, in said substantially shell-like configuration, has a concavity that is directed upward during use.

25. The bed according to claim 22, wherein said resting element has at least two transverse portions that are arranged in succession along said main longitudinal axis, said at least two transverse portions having mutual connection means that are adapted to allow, on command, an angular movement of one transverse portion with respect to the other transverse portion about a transverse axis that is substantially perpendicular to said main longitudinal axis.

26. The bed according to claim 22, wherein said resting element comprises at least three longitudinal elements, which can be moved with respect to each other about respective mutual connection axes in order to shift between said flat condition, in which said at least three longitudinal elements lie substantially on the same plane of arrangement, and a shell-like condition, in which said at least three longitudinal elements cooperate in order to obtain said substantially shell-like configuration.

27. The bed according to claim 23, wherein said conversion means comprise actuation means that are adapted to move said at least three longitudinal elements in an angular fashion with respect to each other about the respective mutual connection axis.

28. The bed according to claim 25, wherein said resting element comprises an internal longitudinal portion and at least two external longitudinal portions that are arranged on opposite sides with respect to said at least one internal longitudinal portion relative to the main longitudinal axis, said at least one internal longitudinal portion and said at least two external longitudinal portions being arranged, when said resting element is in the flat condition, on the same plane of arrangement, said conversion means comprising means for lifting/lowering said at least one internal longitudinal portion with respect to said supporting structure and means for the angular movement, about a respective movement axis that is substantially parallel to the main longitudinal axis, of said pair of external longitudinal portions in order to obtain said shell-like configuration.

29. The bed according to claim 28, wherein said internal longitudinal portion comprises at least one pair of longitudinal members, said supporting structure comprising an external profile that has two supporting bars, each one of said external longitudinal portions being associated with a respective longitudinal member and with a respective supporting bar, which are arranged on the same side with respect to said internal longitudinal portion, said lifting/lowering means being adapted to move said pair of longitudinal members with respect to said external profile along a direction that is substantially perpendicular to the plane of arrangement of said internal longitudinal portion and to move in an angular fashion said external longitudinal portions about a respective angular movement axis.

30. The bed according to claim 29, wherein said at least one pair of longitudinal members support a first plurality of cross-members, which are mutually spaced along said main longitudinal axis, second pluralities of cross-members being provided which are mutually spaced along said main longitudinal axis and are associated with said supporting bars and with said longitudinal members.

31. The bed according to claim 30, wherein each one of said second pluralities of cross-members has a first portion for pivoting to a respective supporting bar and a second end that is supported so that it can slide by a respective longitudinal member.

32. The bed according to claim 29, wherein said longitudinal members have a diverging arrangement at the respective end portions that are located toward the head of the bed.

33. The bed according to claim 29, wherein said movement means comprise motor means that are kinematically connected to at least one movement element, which comprises a respective driving shaft that is adapted to rotate with a back-and-forth motion in order to cause the oscillation of said resting element about said tilting axis.

34. The bed according to claim 33, wherein each transverse portion is associated with a respective movement element.

35. The bed according to claim 22, wherein said resting element comprises an intermediate transverse portion, a transverse head portion and a transverse foot portion, respective mutual connection means being provided between said intermediate transverse portion and said foot portion and between said intermediate transverse portion and said head portion.

36. The bed according to claim 33, wherein it comprises articulation devices between said movement elements arranged in succession.

37. The bed according to claim 22, wherein it comprises a mattress device that is designed to be arranged on top of said resting element during use.

38. The bed according to claim 37, wherein said mattress device comprises a plurality of mattresses that are adapted to arrange their respective peripheral edges at said transverse axes and at said connection means.

39. The bed according to claim 23, wherein said shell-like element is connected to a respective protective side at upper longitudinal edges.

40. The bed according to claim 39, wherein said protective side is associated with guiding means that are adapted to keep said protective side substantially vertical.

41. The bed according to claim 37, wherein it comprises covering means that are detachably associable on top of said mattress device.

42. The bed according to claim 41, wherein said covering means comprise a panel that is shaped like a shell and is substantially impermeable.
